(19) United States
(12) Patent Application Publication
(10) Pub. No.: US 2006/0210789 A1
(43) Pub. Date: Sep. 21, 2006

(54) Skid-proof and ventilated cushion

(75) Inventor: Semi Ko, Chang-Hua Hsien (TW)

Correspondence Address: BRUCE H. TROXELL;SUITE 1404, 5205 LEESBURG PIKE, FALLS CHURCH, VA, 22041, US

(73) Assignee: Shiun Jiug Industrial Co., Ltd.

(21) Appl. No.: 11/082,692

(22) Filed: Mar. 18, 2005

(51) Int. Cl. B32B 3/26; B32B 3/00

(52) U.S. Cl. 428/315.9

(57) ABSTRACT

A cushion has a bottom layer, which is made of a foaming material with a skid-proof capacity, a supporting layer, which is made of an elastic material and molded into a single element, having a first layer attached on the bottom layer, a plurality of supporting posts projected from the first layer and a second layer connected to free ends of the supporting posts, and a top layer, which is made of a foaming material with a skid-proof capacity, attached on the second layer of the supporting layer.

### BACKGROUND OF THE INVENTION

1. Field of the Invention

The present invention relates generally to a cushion, and more particularly to a skid-proof and ventilated elastic cushion.

2. Description of the Related Art

A conventional cushion to absorb impact is made of air pad or foaming material, such as rubber, styrene butadiene rubber (SBR), polyvinyl chloride (PVC), polypropylene (PP), polyurethane (PU) or ethylene vinyl acetate (EVA). The elastic pad made of the foaming material is restricted by the material property that the elastic pad only has one capacity of buffer, vibration damping (absorption of impact) or elasticity (rebounding or offsetting force).

If an elastic cushion can have both capacities of elasticity and vibration damping to be a vibration damping and elastic material, it is a very convenient and economic product.

### SUMMARY OF THE INVENTION

The primary objective of the present invention is to provide a cushion, which has properties of skid-proof, ventilation, elasticity and vibration damping, furthermore, no glue is involved in the cushion of the present ion to reduce the weight thereof.

According to the objective of the present invention, a cushion has a bottom layer, which is made of a foaming material with a skid-proof capacity, a supporting layer, which is made of an elastic material and molded as a single element, having a first layer attached on the bottom layer, a plurality of supporting posts projected from the first layer and a second layer connected to free ends of the supporting posts, and a top layer, which is made of a foaming material with a skid-proof capacity, attached on the second layer of the supporting layer.

### BRIEF DESCRIPTION OF THE DRAWINGS

FIG. 1 is a perspective view of a preferred embodiment of the present invention, and

FIG. 2 is a sectional view of the preferred embodiment of the present invention.

### DETAILED DESCRIPTION OF THE INVENTION

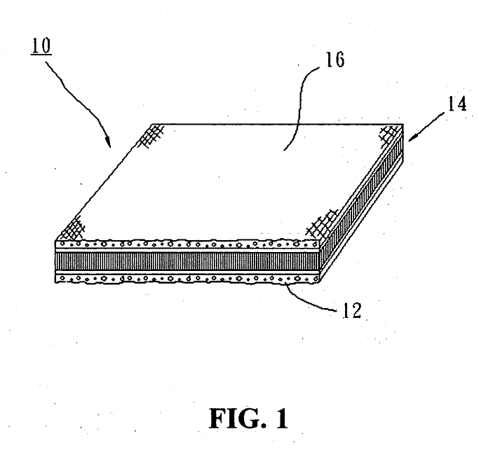

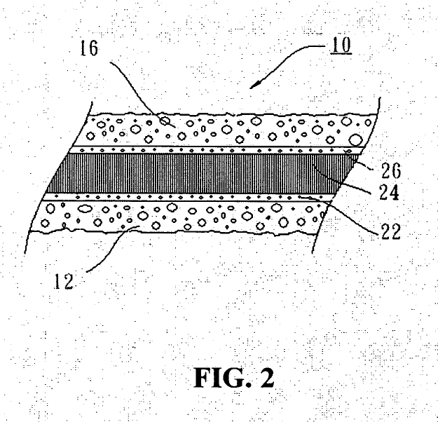

As shown in FIG. 1 and FIG. 2, a cushion 10 of the preferred embodiment of the present invention, which is applied to sport pad or other applications, mainly comprises a bottom layer 12, a supporting layer 14 and a top layer 16.

The bottom layer 12 is made of a porous foaming material with skid-proof capacity, such as natural rubber (NR), polyurethane (PU), polyvinyl chloride (PVC) or styrene butadiene rubber (SBR). In the present invention, the bottom layer 12 is made of natural rubber.

The supporting layer 14 is made of an elastic material, such as natural rubber (NR), nylon, polyethylene (PE), or polyester fibers, and molded into a single element. In the present invention, the supporting layer 14 is made of polyester fibers. The supporting layer 14 has a first layer 22 attached on the bottom layer 12, a plurality of supporting posts 24 projected from a top of the first layer 22, and a second layer 26 connected to free ends of the supporting posts 24.

The top layer 16 is made of a porous foaming material with skid-proof capacity, such as natural rubber (NR), polyurethane (PU), polyvinyl chloride (PVC) or styrene butadiene rubber (SBR). In the present invention, the bottom layer 12 is made of natural rubber.

In fabrication, the supporting layer 14 is stacked on the bottom layer 12, and the top layer 16 is stacked on the supporting layer 14 to perform a foaming process. In the foaming process the bottom layer 12, the supporting layer 14 and the top layer 16 are bonded together by the gas pressure generated from the chemical reaction of a foaming agent.

The cushion 10 of the present invention has a lot of gaps between the supporting posts 24 of the supporting layer 14 that serves the capacity of elasticity. The top and bottom layers 16 and 12 of the cushion 10 serve the capacities of skid-proof, elasticity and vibration damping. With the supporting layer 14 of the cushion 10 of the present invention, the thickness of the top and bottom layers 16 and 12 are reduced to increase the weight of the cushion 10 of the present invention. Furthermore, no glue is involved in the cushion 10 of the present invention.

It has to be mentioned that the top and bottom layers 16 and 12 can be made of different materials to have the cushion 10 of the present invention with various material capacities.

In conclusion, the cushion of the present invention has both capacities of elasticity and vibration damping. It has no glue and less foaming material to have the cushion with lighter weight.

What is claimed is:

1. A cushion, comprising:
a bottom layer made of a foaming material with a skid-proof capacity;
a supporting layer, which is made of an elastic material and molded into a single element, having a first layer attached on the bottom layer, a plurality of supporting posts projected from the first layer and a second layer connected to free ends of the supporting posts, and
a top layer, which is made of a foaming material with a skid-proof capacity, attached on the second layer of the supporting layer.

2. The cushion as defined in claim 1, wherein the foaming material of the bottom layer is chosen from natural rubber, polyurethane (PU), polyvinyl chloride (PVC) and styrene butadiene rubber (SBR).

3. The cushion as defined in claim 1, wherein the foaming material of the top layer is chosen from natural rubber, polyurethane (PU), Polyvinyl Chloride (PVC) and styrene butadiene rubber (SBR).

4. The cushion as defined in claim 1, wherein the elastic material of the top layer is chosen from natural rubber (NR), nylon, polyethylene (PE) and polyester fibers.
